(19) United States
(12) Patent Application Publication
(10) Pub. No.: US 2026/0295546 A1
(43) Pub. Date: Oct. 1, 2026

(54) MULTI-PUMPS AND MULTI-CYCLES SYSTEMS FOR BLENDING AND JUICING

(71) Applicant: Peter Groz STEVENS, Krastevich (BG)

(72) Inventor: Peter Groz STEVENS, Krastevich (BG)

(21) Appl. No.: 19/636,337

(22) Filed: Apr. 1, 2026

Related U.S. Application Data
(60) Provisional application No. 63/781,837, filed on Apr. 1, 2025.

(51) Int. Cl. B01F 33/70; A23L 2/04; A23N 1/02; B01F 27/808; B01F 33/80; B01F 33/83; B01F 101/06; B01F 101/14

(52) U.S. Cl. CPC B01F 33/70; A23L 2/04; A23N 1/02; B01F 27/808; B01F 33/83; B01F 33/83611; B01F 2101/06; B01F 2101/14

(57) ABSTRACT

A system can include a container including an opening and a blade configured to cut organic material, a gas source in fluid communication with the opening, a valve controller in fluid communication with the gas source, a first vacuum pump in fluid communication with the container, and a second vacuum pump in fluid communication with the first vacuum pump. The first vacuum pump and the second vacuum pump can be configured to draw gas from the container through the opening. The valve controller can be configured to inject gas from the gas source into the container through the opening.

### CROSS-REFERENCE TO RELATED APPLICATION

This application claims the benefit of and priority to U.S. Provisional Patent Application No. 63/781,837 entitled “MULTI-PUMPS AND MULTI-CYCLES SYSTEMS FOR BLENDING AND JUICING” filed on Apr. 1, 2025, the contents of which are incorporated by reference in their entirety for all purposes.

### BACKGROUND

The present disclosure relates generally to food processing appliances. Food processing appliances such as blenders and juicers are commonly used to prepare smoothies, juices, and other blended or extracted food products. During operation, vigorous agitation or cutting of food creates bubbles and exposes food surfaces to air, which contains oxygen that can react with sensitive food molecules and degrade nutritional quality.

### SUMMARY

At least one embodiment relates to a system. The system can include a container including an opening and a blade configured to cut organic material. The system can include a gas source in fluid communication with the opening. The system can include a valve controller in fluid communication with the gas source. The system can include a first vacuum pump in fluid communication with the container. The system can include a second vacuum pump in fluid communication with the first vacuum pump. The first vacuum pump and the second vacuum pump are configured to draw gas from the container through the opening. The valve controller is configured to inject gas from the gas source into the container through the opening.

In some embodiments, the system can include a controller including a processor and one or more memories configured to control a speed of the blade, a gas flow through the valve controller, a suction of the first vacuum pump, or a suction of the second vacuum pump. In some embodiments, the system can include an isolating assembly disposed between the opening and an inlet of the first vacuum pump. In some embodiments, the isolating assembly is configured to obstruct solid and liquid organic material from exiting the container through the opening.

In some embodiments, the isolating assembly can include an isolating module. In some embodiments, the isolating assembly can include a membrane positioned within the isolating module. In some embodiments, the membrane is configured to facilitate gas flow and obstruct solid and liquid organic material. In some embodiments, the valve controller can include an internal valve system configured to switch between a first gas input in fluid communication with the gas source and a second gas source in fluid communication with an ambient air source. In some embodiments, the internal valve system is configured to output gas through an outlet.

In some embodiments, the valve controller can include a graphical user interface configured to display system information including a pressure of the system, contents of the container, or a cycle indicator. In some embodiments, the container can include a cup configured to receive organic material therein. In some embodiments, the container can include a lid configured to seal an opening of the cup. In some embodiments, the opening of the container is disposed in the lid. In some embodiments, the container can include a motor disposed on a surface of the cup opposite the opening of the cup. In some embodiments, the motor is coupled to and configured to actuate the blade.

In some embodiments, the system can include a third vacuum pump in fluid communication with the second vacuum pump and configured to draw gas from the container through the opening.

At least one other aspect relates to a method. The method can be performed, for example, by one or more processors coupled to non-transitory memory. The method can include adding organic material to a container. The method can include coupling an opening of the container to a gas pathway, the gas pathway including a valve controller and a vacuum system having a first vacuum pump and a second vacuum pump. The method can include drawing, by the vacuum system, a first gas from the container through the opening. The method can include injecting, by the valve controller, a second gas into the container. The method can include cutting, by a blade disposed in the container, the organic material.

In some embodiments, the method can include drawing, after injecting the second gas into the container, by the vacuum system, the second gas from the container. In some embodiments, the method can include injecting, by the valve controller, the second gas into the container. In some embodiments, the second gas is an inert gas. In some embodiments, the method can include disposing a membrane between the opening of the container and the first vacuum pump. In some embodiments, the vacuum system can include a third vacuum pump.

In some embodiments, the method can include displaying, by a graphical user interface disposed on the valve controller, system information including a pressure of the vacuum system, contents of the container, or a cycle indicator. In some embodiments, the blade is disposed on a surface of the container opposite the opening. In some embodiments, the method can include injecting, after the second gas is injected into the container, by the valve controller, the first gas into the container. In some embodiments, the first gas is ambient air.

At least one other aspect relates to a method. The method can be performed, for example, by one or more processors coupled to non-transitory memory. The method can include adding organic material to a container. The method can include drawing, by a vacuum system including a first vacuum and a second vacuum, a first gas from the container. The method can include displaying, by a graphical user interface disposed on a valve controller, a first pressure indicator of the container. The method can include injecting, by the valve controller, a second gas into the container. The method can include displaying, by the graphical user interface, a second pressure indicator and a gas composition indicator of the container. The method can include cutting, by a blade disposed in the container, the organic material.

In some embodiments, the method can include displaying, by the graphical user interface, a status of the organic material. In some embodiments, the second gas has a pressure higher than 1.1 atm and a temperature colder than 15 degrees Celsius.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements.

FIG. 1 is an overview of a blender system including a blender, an isolating assembly, vacuum pumps, an inert gas source, a valve controller, and a processing unit, according to an exemplary embodiment.

FIG. 2 is a schematic view of a blender cup in which foodstuff is blended beneath a sealed lid having an opening for evacuation and inert gas flow, according to an exemplary embodiment.

FIG. 3 is a set of views of an isolating module for an isolation assembly configured to permit gas flow while restricting migration of foodstuff, according to an exemplary embodiment.

FIG. 4 is a schematic diagram illustrating vacuum pumps connected in series, according to an exemplary embodiment.

FIG. 5 is a schematic diagram of a source of inert gas, according to an exemplary embodiment.

FIG. 6 is a schematic diagram of a valve regulating unit, according to an exemplary embodiment.

FIG. 7 is a block diagram illustrating a processing unit and controlled system elements, according to an exemplary embodiment.

FIG. 8 is a table showing an example of partial pressure of oxygen for different numbers of pumps and cycles, according to an exemplary embodiment.

FIG. 9 is a table showing ratios of oxygen for different numbers of pumps and cycles relative to a single-pump configuration, according to an exemplary embodiment.

FIG. 10 is an overview of a juicer system, according to an exemplary embodiment.

FIG. 11 is a flow chart illustrating a method for reducing oxygen exposure while processing organic material in a container, according to an exemplary embodiment.

FIG. 12 is a flow chart illustrating a method for reducing oxygen in a container before cutting organic material, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Blender systems and juicer systems are used to process foodstuff for consumption. A blender system can include a motor-driven blade assembly disposed within a cup. The cup can be sealed with a lid. During blending, the blade assembly can agitate the foodstuff, creating bubbles and exposing the foodstuff to air present in a headspace above the foodstuff. Juicer systems can include a masticating or cutting mechanism that processes food to extract juice. The juice and pulp can be collected in separate containers. Both types of systems can operate in the presence of atmospheric air during processing.

Atmospheric air contains approximately twenty percent oxygen by volume. Oxygen can react with sensitive molecules in foodstuff, leading to oxidation. Oxidation can degrade nutritional quality and produce reactive oxygen species. During vigorous blending or juicing, the creation of bubbles and increased surface area can increase the contact between oxygen and foodstuff molecules. Some existing systems use a single vacuum pump to reduce pressure in the headspace before processing. However, a single vacuum pump can achieve only limited pressure reduction, typically leaving a substantial amount of oxygen in the headspace. The limited reduction in oxygen concentration can result in continued oxidative damage to the foodstuff during processing.

The techniques described herein relate to systems and methods for reducing oxygen concentration in a sealed processing environment using multiple vacuum pumps connected in series and optional inert gas cycling. The systems can include a sealed container configured to hold foodstuff, a valve regulating unit, an inert gas source, and a series vacuum pump assembly. The valve regulating unit can selectively admit atmospheric air or inert gas into the container. The series vacuum pump assembly can evacuate gas from the container through multiple stages, achieving a lower final pressure than a single-pump configuration.

A blender system can include a cup configured to receive foodstuff, a motor-driven blade assembly, and a hermetically sealed lid. The lid can include an opening in fluid communication with an isolating assembly. The isolating assembly can be positioned between the cup and downstream vacuum components. The isolating assembly can include one or more isolating modules, each module having a membrane configured to permit bidirectional gas flow while restricting migration of foodstuff toward the vacuum pumps and valve regulating unit. The isolating assembly can prevent clogging of the vacuum pump inlet and valves. The system can include multiple vacuum pumps connected in series. The inlet of a first vacuum pump can be connected to the cup headspace through the isolating assembly and valve regulating unit. The outlet of each vacuum pump can be connected to the inlet of a subsequent vacuum pump. The outlet of the last vacuum pump can vent to ambient air or another selected environment. The system can include an inert gas source, such as a pressurized bottle containing nitrogen or a device that produces inert gas. The valve regulating unit can include valves that separate an air inlet from an inert gas inlet. The valves can selectively regulate flow to the cup headspace. A processing unit can control the motor, the vacuum pumps, and the valves. A juicer system can be arranged on similar principles, but adapted for juicing. The juicer system can include a hermetically sealable enclosed volume surrounding juicing components, such as a masticator or cutting component, a juice-draining cup, and a container for food to be juiced. The food container can include hermetically sealed gloves permitting manual handling of food without breaking the seal, or the food container can automatically feed food to the juicer. The enclosed volume can also include a compartment for pulp. The juicer system can omit the isolating assembly.

The techniques described herein can overcome the limitations of single-pump systems by using multiple vacuum pumps in series to achieve a lower final pressure in the headspace, such that the concentration of oxygen is reduced more than with a single pump. Each successive pump in the series can further reduce pressure relative to the preceding stage. The final headspace pressure can decrease as a function of the number of pumps and their inlet-to-outlet pressure ratio. For example, if each pump reduces pressure to thirty percent of its inlet pressure, three pumps in series can reduce the headspace pressure to approximately 2.7 percent of the initial atmospheric pressure, compared to thirty percent with a single pump. The techniques can further reduce oxygen concentration by performing multiple evacuation and inert gas refill cycles. After an evacuation cycle, inert gas can be admitted into the headspace. The evacuation followed by inert gas admission can be repeated for multiple cycles. Each cycle can reduce oxygen concentration further by diluting remaining oxygen with inert gas before the next evacuation. The isolating assembly can prevent foodstuff from migrating toward the vacuum pumps and valve regulating unit during evacuation and inert gas admission, such that the pumps and valves remain unclogged and the tubing above the isolating assembly remains clean. The techniques can also include introducing inert gas at a pressure higher than ambient before a subsequent evacuation cycle, such that the oxygen-to-inert-gas ratio is further reduced before that cycle begins. After the final evacuation cycle, inert gas can be introduced and left in the headspace during processing at a selected pressure, such that oxygen interaction during processing is further reduced. The techniques can also include introducing lower-temperature inert gas during processing, such that the number of collisions between oxygen molecules and foodstuff molecules is reduced. The techniques can also include adding ice cubes or cold water to the foodstuff prior to processing, such that the kinetic energy of foodstuff molecules is reduced and oxidation is further reduced. While the present disclosure refers to foodstuff processing, the contents of the containers and other apparatuses disclosed herein can be applied to any organic material (e.g., foodstuff, fruit, vegetables, protein powder, nut-based materials, milk, water, algae, fungus, plants, leaves, or any edible or non-edible organic material).

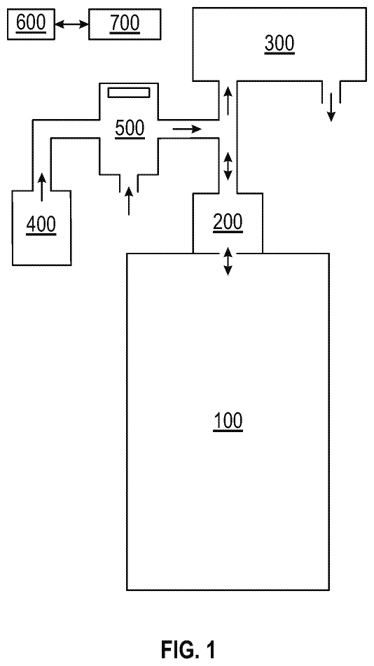

Referring to FIG. 1, a blender system 100 integrates vacuum-based atmosphere control with food processing capability in a sealed environment. The blender system 100 includes a container (e.g., cup, vessel, bowl, etc.) configured to hold foodstuff for processing. The blender system 100 includes an isolating assembly 200 positioned between the container and downstream fluid-handling components. The blender system 100 includes an assembly of vacuum pumps 300 connected in series to evacuate gas from a headspace above the foodstuff. The blender system 100 includes an inert gas source 400 configured to supply inert gas (e.g., nitrogen, argon, etc.) to the container. The blender system 100 includes a valve controller 500 configured to selectively regulate flow of atmospheric air and/or inert gas into the container. The blender system 100 includes a processing unit 600 configured to coordinate operation of the vacuum pumps, the valve controller 500, and a motor-driven blade assembly within the container. The blender system 100 includes elements of the system 700 controlled by the processing unit 600, such as the motor, the vacuum pumps, and the valves within the valve controller 500.

The isolating assembly 200 couples to an opening in a lid of the container and prevents liquid and/or solid foodstuff from migrating toward the assembly of vacuum pumps 300 and the valve controller 500 during evacuation and/or inert gas admission. The isolating assembly 200 permits bidirectional gas flow between the headspace and the assembly of vacuum pumps 300. The assembly of vacuum pumps 300 is fluidly coupled to the isolating assembly 200 through vacuum-sealed tubing. The assembly of vacuum pumps 300 is configured to draw gas from the headspace through the isolating assembly 200, reducing pressure in the headspace to a level determined by the number of pumps in series and their respective inlet-to-outlet pressure ratios. The inert gas source 400 is fluidly coupled to the valve controller 500. The valve controller 500 is fluidly coupled to the isolating assembly 200. The valve controller 500 includes an internal valve system configured to switch between admitting atmospheric air from an ambient environment and admitting inert gas from the inert gas source 400. The processing unit 600 is electrically coupled to the assembly of vacuum pumps 300, the valve controller 500, and the motor-driven blade assembly. The processing unit 600 is configured to activate the assembly of vacuum pumps 300 to evacuate the headspace, activate the valve controller 500 to admit inert gas into the headspace, and activate the motor-driven blade assembly to blend the foodstuff after a desired oxygen concentration has been reached.

During operation, the processing unit 600 controls a sequence of evacuation and inert gas admission cycles to reduce oxygen concentration in the headspace. The processing unit 600 activates the assembly of vacuum pumps 300 while the valve controller 500 keeps both air and inert gas inlets closed, such that gas is evacuated from the headspace through the isolating assembly 200. The assembly of vacuum pumps 300 reduces pressure in the headspace to a fraction of atmospheric pressure determined by the number of pumps in series. For example, if three pumps are connected in series and each pump reduces its inlet pressure to thirty percent of its outlet pressure, the final headspace pressure is reduced to approximately 2.7 percent of atmospheric pressure. After the evacuation cycle, the processing unit 600 activates the valve controller 500 to open the inert gas inlet, allowing inert gas from the inert gas source 400 to flow through the isolating assembly 200 into the headspace. The inert gas dilutes any remaining oxygen in the headspace. The processing unit 600 repeats the evacuation and inert gas admission cycles as needed to achieve a target oxygen concentration. After the final cycle, the processing unit 600 activates the motor-driven blade assembly to blend the foodstuff in the reduced-oxygen environment.

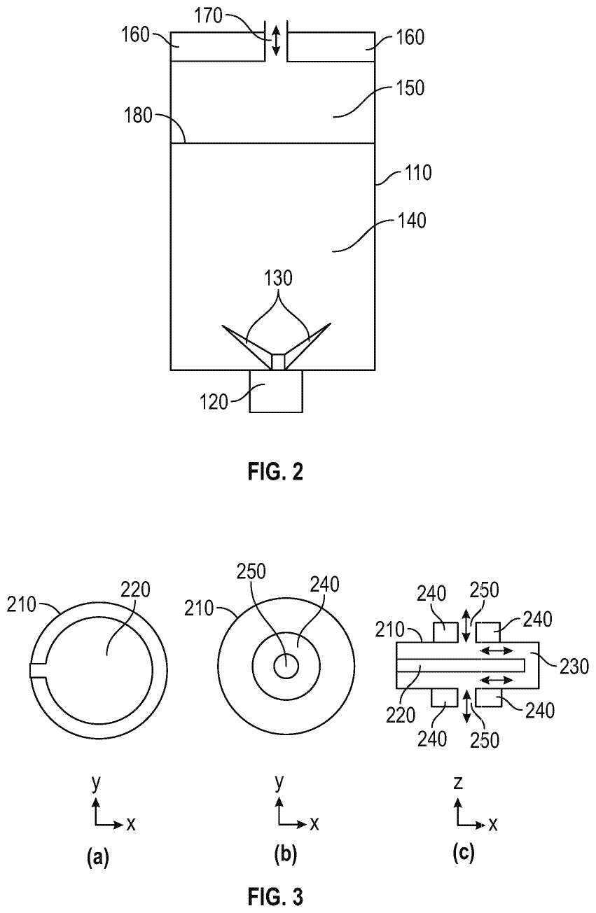

Referring to FIG. 2, the blender system 100 includes a cup 110 configured to receive and contain foodstuff during processing. The cup 110 forms a sealed processing chamber when closed and supports multiple functional components arranged in a specific spatial configuration. The cup 110 includes a motor 120 positioned at a base region of the cup 110. The motor 120 is mechanically coupled to a set of blades 130 that extend upward into an interior volume of the cup 110. The blades 130 are configured to rotate under actuation from the motor 120 to cut and agitate organic material placed within the cup 110. The cup 110 defines a foodstuff volume 140 that receives the organic material for processing. The foodstuff volume 140 is bounded below by the blades 130 and above by a space 150. The space 150 is positioned above the foodstuff volume 140 and forms a headspace region when the foodstuff volume 140 is partially filled with organic material. A top surface 180 of the foodstuff volume 140 forms a boundary between the foodstuff volume 140 and the space 150 when organic material is present in the cup 110.

The cup 110 further includes a lid 160 that seals the cup 110 to establish a hermetic seal over the space 150 and the foodstuff volume 140. The lid 160 is removably coupled to an upper rim of the cup 110 and forms a barrier preventing atmospheric air from entering the space 150 during operation. The lid 160 includes an opening 170 that extends through a thickness of the lid 160 and provides fluid communication between the space 150 and external components. The opening 170 is positioned such that the opening 170 does not extend into the foodstuff volume 140 when the lid 160 is sealed and the foodstuff volume 140 is filled to a level below the opening 170. The opening 170 is fluidly coupled to the isolating assembly 200 such that gas flow between the space 150 and the assembly of vacuum pumps 300 passes through the opening 170. In some embodiments, the opening 170 is sized to accommodate a coupling interface of the isolating assembly 200, for example, by providing a threaded connection or a press-fit seal.

During operation, the motor 120 drives rotation of the blades 130 to process organic material contained within the foodstuff volume 140. The sealed configuration established by the lid 160 isolates the space 150 from atmospheric air such that evacuation and inert gas admission cycles modulate gas composition within the space 150 without leakage. The assembly of vacuum pumps 300 draws gas from the space 150 through the opening 170, reducing pressure in the space 150 and thereby reducing oxygen concentration above the top surface 180 of the foodstuff volume 140. The valve controller 500 selectively admits inert gas through the opening 170 into the space 150 after an evacuation cycle, establishing a low-oxygen atmosphere above the foodstuff volume 140 before the motor 120 actuates the blades 130. The isolating assembly 200 prevents liquid and/or solid organic material from migrating from the space 150 toward the assembly of vacuum pumps 300 during evacuation and inert gas admission, such that the opening 170 remains unobstructed and gas flow remains unimpeded. In some embodiments, the top surface 180 of the foodstuff volume 140 moves downward during evacuation as the space 150 expands under reduced pressure, for example, when the foodstuff volume 140 contains compressible organic material.

Referring to FIG. 3, an isolating module 210 forms a barrier component positioned between the opening 170 of the lid 160 and the inlet 311 of the first vacuum pump 310. The isolating module 210 includes a structural body, housing, or enclosure, shown as structure 230, that defines an internal volume and establishes a gas flow path through the isolating module 210. The structure 230 supports a barrier element, filter, or membrane, shown as membrane 220, within the internal volume. The membrane 220 extends across a portion of the internal volume and permits gas to pass through the membrane 220 in both directions while restricting solid and/or liquid foodstuff from migrating through the isolating module 210. In some embodiments, the membrane 220 includes a porous material that allows gas molecules to traverse the membrane 220 while blocking larger particles. For example, the membrane 220 may include a mesh, screen, or perforated sheet having pore sizes selected to permit gas flow while obstructing particles above a threshold size. The structure 230 defines at least one gas passage, aperture, or opening, shown as flow opening 250, that provides fluid communication between the internal volume and an external environment. In some embodiments, the flow opening 250 is positioned on a first side of the structure 230 and a second flow opening 250 is positioned on an opposite side of the structure 230, such that gas enters the isolating module 210 through the first flow opening 250, traverses the membrane 220, and exits through the second flow opening 250.

The isolating module 210 further includes a mechanical interface, attachment feature, or connector, shown as coupling part 240, that mechanically couples the isolating module 210 to at least one of the lid 160 or an adjacent isolating module 210. The coupling part 240 extends from an exterior surface of the structure 230 and forms a releasable connection that maintains a vacuum seal during evacuation and inert gas admission cycles. In some embodiments, the coupling part 240 includes a threaded interface that mates with a corresponding threaded surface on the lid 160. For example, the coupling part 240 may include external threads that engage internal threads formed within the opening 170 of the lid 160, such that rotation of the isolating module 210 about a longitudinal axis of the coupling part 240 secures the isolating module 210 to the lid 160. In some embodiments, the coupling part 240 includes a press-fit interface that engages an inner surface of the opening 170 or an inner surface of an adjacent isolating module 210. The coupling part 240 is sized to withstand forces exerted by pressure differences between the space 150 and ambient pressure during evacuation cycles, such that the coupling part 240 resists decoupling under vacuum conditions. The isolating assembly 200 may include multiple isolating modules 210 stacked in series, with the coupling part 240 of a first isolating module 210 coupled to the lid 160 and the coupling part 240 of a second isolating module 210 coupled to a corresponding interface on the first isolating module 210, such that gas flows sequentially through each membrane 220 in the series.

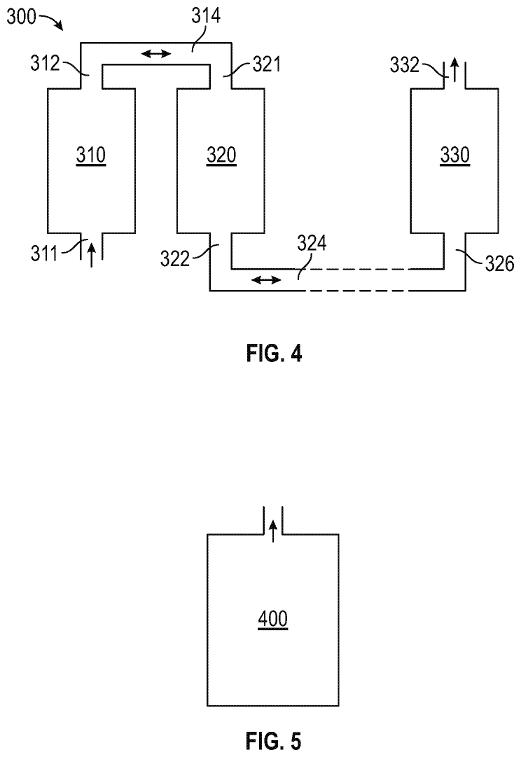

Referring to FIG. 4, the assembly of vacuum pumps 300 includes multiple vacuum stages (e.g., pumps, evacuation stages, pressure-reduction stages, etc.) connected in series to achieve reduced pressure in the space 150 of the cup 110. The assembly of vacuum pumps 300 includes a first vacuum pump 310 positioned upstream in the gas flow path. The first vacuum pump 310 includes an inlet 311 that couples to the isolating assembly 200 through vacuum-sealed tubing, establishing fluid communication with the space 150. The first vacuum pump 310 further includes an outlet 312 that expels gas at a pressure higher than the pressure at the inlet 311. The assembly of vacuum pumps 300 includes a second vacuum pump 320 positioned downstream from the first vacuum pump 310 in the gas flow path. The second vacuum pump 320 includes an inlet 321 and an outlet 322. The assembly of vacuum pumps 300 includes a shared space 314 positioned between the outlet 312 of the first vacuum pump 310 and the inlet 321 of the second vacuum pump 320, such that gas expelled from the outlet 312 enters the shared space 314 and subsequently flows into the inlet 321. In some embodiments, the shared space 314 includes a length of vacuum-sealed tubing coupling the outlet 312 to the inlet 321. In some embodiments, the shared space 314 includes a manifold or chamber positioned between the outlet 312 and the inlet 321.

The assembly of vacuum pumps 300 further includes additional downstream vacuum stages to further reduce pressure in the space 150. The assembly of vacuum pumps 300 includes a shared space 324 between adjacent pumps in the series, where the shared space 324 couples an outlet of one pump to an inlet of a subsequent pump in the series. For example, the shared space 324 may couple the outlet 322 of the second vacuum pump 320 to an inlet of a third vacuum pump (not shown), such that gas flows from the outlet 322 into the shared space 324 and then into the inlet of the third vacuum pump. The shared space 324 can couple one additional pump, two additional pumps, three additional pumps, four additional pumps, five additional pumps, six additional pumps, seven additional pumps, eight additional pumps, nine additional pumps, ten additional pumps, or more additional pumps to the assembly of vacuum pumps 300. The assembly of vacuum pumps 300 includes a last vacuum pump 330 positioned at a terminal downstream position in the series. The last vacuum pump 330 includes an inlet 326 that receives gas from an upstream shared space 324 or from an upstream pump outlet. The last vacuum pump 330 further includes an outlet 332 that expels gas to an external environment. In some embodiments, the outlet 332 vents to ambient atmospheric air. In some embodiments, the outlet 332 vents to a selected external environment having a pressure different from ambient atmospheric pressure.

During operation, the processing unit 600 activates the first vacuum pump 310, the second vacuum pump 320, and the last vacuum pump 330 simultaneously to evacuate gas from the space 150. The first vacuum pump 310 draws gas from the space 150 through the inlet 311, reducing pressure in the space 150 to a first reduced pressure determined by an inlet-to-outlet pressure ratio of the first vacuum pump 310. For example, if the first vacuum pump 310 reduces its inlet pressure to thirty percent of its outlet pressure, the pressure in the space 150 is reduced to approximately thirty percent of the initial pressure in the space 150. The first vacuum pump 310 expels gas through the outlet 312 into the shared space 314 at the first reduced pressure. The second vacuum pump 320 draws gas from the shared space 314 through the inlet 321 and further reduces pressure in the shared space 314 according to its inlet-to-outlet pressure ratio. The second vacuum pump 320 expels gas through the outlet 322 at a second reduced pressure lower than the first reduced pressure. Gas flows sequentially through each subsequent pump in the assembly of vacuum pumps 300, with each pump further reducing pressure relative to its upstream neighbor. The last vacuum pump 330 draws gas through the inlet 326 and expels gas through the outlet 332 to the external environment. The cumulative pressure reduction achieved by the assembly of vacuum pumps 300 is determined by the number of pumps in the series and the inlet-to-outlet pressure ratio of each pump, such that the final pressure in the space 150 is lower than achievable with a single vacuum pump.

Referring to FIG. 5, the inert gas source 400 provides a supply of inert gas to the valve controller 500 for selective introduction into the space 150 above the foodstuff volume 140. The inert gas source 400 includes a pressurized container, a gas-generating device, or a hybrid arrangement combining both stored-gas and gas-generation functionality. In some embodiments, the inert gas source 400 includes a pressurized bottle containing an inert gas such as nitrogen, argon, or another low-reactivity gas. For example, the pressurized bottle may be a standard compressed gas cylinder rated to store nitrogen at a pressure ranging from approximately 10 atmospheres to approximately 200 atmospheres. In some embodiments, the inert gas source 400 includes a gas-generating device that actively produces inert gas on demand. For example, the gas-generating device may include a membrane separator that extracts nitrogen from atmospheric air by selective permeation or a chemical generator that produces nitrogen through a controlled reaction. The inert gas source 400 is fluidly coupled to the inert gas inlet 530 of the valve controller 500 through a conduit, such that gas flows from the inert gas source 400 to the valve controller 500 when the valve controller 500 opens the inert gas inlet 530. The processing unit 600 controls the flow rate and pressure of inert gas delivered from the inert gas source 400 to the space 150 by actuating valves within the valve controller 500, establishing a selected pressure of inert gas within the space 150 after an evacuation cycle. In some embodiments, the inert gas source 400 includes a pressure regulator positioned between the pressurized container and the inert gas inlet 530 to modulate the delivery pressure of the inert gas to a level suitable for the valve controller 500. For example, the pressure regulator may reduce the storage pressure of nitrogen from approximately 150 atmospheres to approximately 2 atmospheres before the nitrogen enters the inert gas inlet 530.

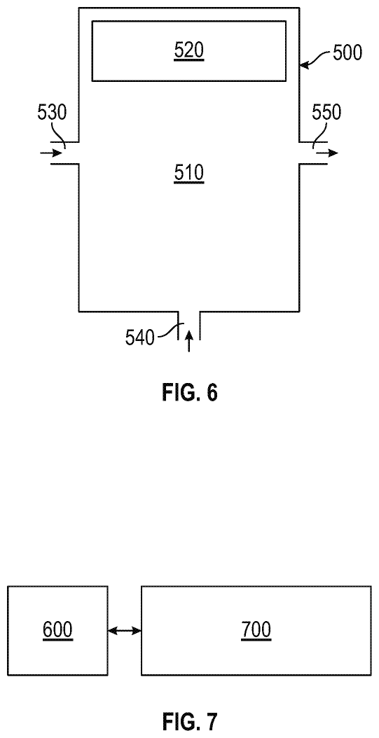

Referring to FIG. 6, the valve controller 500 regulates fluid admission into the space 150 of the cup 110 and selectively controls whether atmospheric air or inert gas enters the space 150 during evacuation and inert gas cycling operations. The valve controller 500 includes a valves regulating part 510 that receives gas from multiple sources and directs gas flow to a common outlet 550 based on control signals from the processing unit 600. The valve controller 500 further includes a user interface 520 that displays operational information and receives user inputs. The valve controller 500 includes an inert gas inlet 530 that couples to the inert gas source 400 and admits inert gas into the valves regulating part 510 when the processing unit 600 activates an inert gas valve within the valves regulating part 510. The valve controller 500 includes an air inlet 540 that admits atmospheric air from an external environment into the valves regulating part 510 when the processing unit 600 activates an air valve within the valves regulating part 510. The valve controller 500 includes the common outlet 550 that expels gas from the valves regulating part 510 toward the isolating assembly 200 and the opening 170 of the lid 160, such that gas admitted through either the inert gas inlet 530 or the air inlet 540 flows through the common outlet 550 to the space 150.

The valves regulating part 510 includes an internal valve system that separates the inert gas inlet 530 from the air inlet 540 and prevents simultaneous flow of atmospheric air and inert gas into the space 150. In some embodiments, the internal valve system includes a first valve positioned between the inert gas inlet 530 and the common outlet 550 and a second valve positioned between the air inlet 540 and the common outlet 550, such that the processing unit 600 activates the first valve to admit inert gas while the second valve remains closed, or activates the second valve to admit atmospheric air while the first valve remains closed. In some embodiments, the internal valve system includes a rotary valve having a rotor that selectively aligns an internal passage with either the inert gas inlet 530 or the air inlet 540 based on a rotational position of the rotor. For example, the rotary valve may rotate ninety degrees to connect the inert gas inlet 530 to the common outlet 550, or rotate to a second position to connect the air inlet 540 to the common outlet 550. The processing unit 600 controls the position of the first valve, the second valve, and/or the rotor by transmitting control signals to actuators coupled to the valves, such that the valves regulating part 510 admits gas from a selected source in response to the control signals. The internal valve system can be configured to output gas through the common outlet 550.

The user interface 520 is electrically coupled to the processing unit 600 and displays operational information during evacuation and inert gas cycling operations. In some embodiments, the user interface 520 includes a display screen that presents pressure values, gas composition indicators, cycle progress indicators, and/or operational status messages. For example, the user interface 520 may display a current pressure in the space 150 in units of atmospheres or kilopascals, and may update the displayed pressure value as the assembly of vacuum pumps 300 reduces pressure during an evacuation cycle. In some embodiments, the user interface 520 includes input elements that receive user commands to initiate evacuation cycles, select a number of evacuation and inert gas admission cycles, or activate the motor 120 to blend the foodstuff. For example, the input elements may include buttons, touch-sensitive regions on the display screen, or rotary dials that generate electrical signals when actuated by a user, such that the processing unit 600 receives the electrical signals and executes operations corresponding to the user commands.

Referring to FIG. 7, the processing unit 600 includes a processor and one or more memories configured to coordinate and control operations of multiple system components. The processing unit 600 is electrically coupled to the elements of the system 700 controlled by the processing unit 600, such that the processing unit 600 transmits control signals to actuate and regulate the elements of the system 700. The elements of the system 700 include the motor 120, the assembly of vacuum pumps 300, and the valve controller 500. The processing unit 600 generates control signals based on a sequence of evacuation and inert gas admission cycles, such that the assembly of vacuum pumps 300 reduces pressure in the space 150 and the valve controller 500 admits inert gas into the space 150 at selected intervals. In some embodiments, the processing unit 600 receives input signals from the user interface 520 indicating a selected number of evacuation cycles, a target oxygen concentration, and/or a blending duration. For example, the user interface 520 may transmit a signal indicating that three evacuation cycles are selected, and the processing unit 600 generates control signals to actuate the assembly of vacuum pumps 300 three times and the valve controller 500 two times between the evacuation cycles. The processing unit 600 further monitors pressure values within the space 150 by receiving sensor signals from pressure sensors (not shown) positioned along the gas pathway between the space 150 and the assembly of vacuum pumps 300. The processing unit 600 compares the received pressure values to threshold values stored in the one or more memories and terminates an evacuation cycle when the received pressure value reaches the threshold value.

During operation, the processing unit 600 executes a control sequence that reduces oxygen concentration in the space 150 before the motor 120 activates the blades 130. The processing unit 600 begins by transmitting a first control signal to the assembly of vacuum pumps 300, activating the first vacuum pump 310, the second vacuum pump 320, and any additional downstream pumps in the series. The assembly of vacuum pumps 300 evacuates gas from the space 150 through the isolating assembly 200 until the pressure in the space 150 decreases to a target pressure determined by the number of pumps and their respective inlet-to-outlet pressure ratios. The processing unit 600 then transmits a second control signal to the valve controller 500, activating an inert gas valve within the valves regulating part 510 to admit inert gas from the inert gas source 400 into the space 150. The processing unit 600 monitors the pressure in the space 150 during inert gas admission and terminates inert gas flow when the pressure reaches a selected pressure, such as atmospheric pressure or a pressure higher than atmospheric pressure. The processing unit 600 repeats the evacuation and inert gas admission cycles a selected number of times, with each cycle further reducing oxygen concentration in the space 150. After the final evacuation cycle and final inert gas admission, the processing unit 600 transmits a third control signal to the motor 120, activating rotation of the blades 130 to blend the foodstuff in the reduced-oxygen environment. In some embodiments, the processing unit 600 transmits a control signal to the valve controller 500 after blending to open the air inlet 540, admitting atmospheric air into the space 150 to equalize pressure before the lid 160 is removed. The processing unit 600 can include a processor and/or one or more memories configured to control a speed of the blade 130, a gas flow through the valve controller 500, a suction of the first vacuum pump 310, and/or a suction of the second vacuum pump 320.

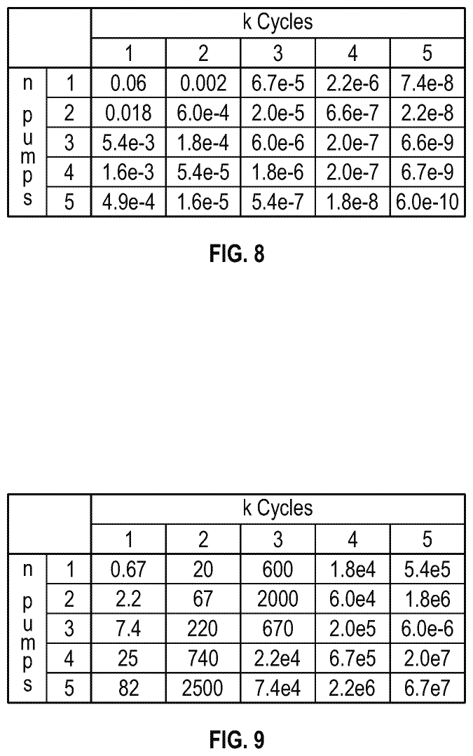

Referring to FIG. 8, a table illustrates calculated partial pressures of oxygen within the space 150 of the cup 110 for various combinations of vacuum pump quantities and evacuation cycle counts. The table displays oxygen partial pressure values organized by the number of pumps (n) in the assembly of vacuum pumps 300 along a vertical axis and the number of evacuation and inert gas admission cycles (k) along a horizontal axis. Each entry in the table represents a final oxygen partial pressure expressed as a fraction of the initial atmospheric oxygen partial pressure, such that lower numerical values indicate greater oxygen reduction. For example, when the assembly of vacuum pumps 300 includes one vacuum pump (n=1) and a single evacuation cycle is performed (k=1), the partial pressure of oxygen decreases to approximately 0.06 atmospheres. In some embodiments, the assembly of vacuum pumps 300 includes three vacuum pumps (n=3) and three evacuation cycles are performed (k=3), such that the partial pressure of oxygen decreases to approximately 6.0×10⁻⁶ atmospheres. In some embodiments, the assembly of vacuum pumps 300 includes five vacuum pumps (n=5) and five evacuation cycles are performed (k=5), such that the partial pressure of oxygen decreases to approximately 6.0×10⁻¹^{⁰} atmospheres. The table demonstrates that increasing either the number of pumps or the number of cycles reduces oxygen partial pressure, with the combined effect of multiple pumps and multiple cycles achieving substantially lower oxygen concentrations than a single pump and single cycle configuration.

Referring to FIG. 9, a comparison table illustrates relative oxygen concentration factors achieved by the assembly of vacuum pumps 300 and the blender system 100 when compared to a baseline single-pump configuration. The table organizes concentration ratio values by the number of pumps (n) in the assembly of vacuum pumps 300 along a vertical axis and the number of evacuation and inert gas admission cycles (k) along a horizontal axis. Each entry in the table represents a multiplicative factor indicating how many times more oxygen remains in a baseline single-pump system relative to the corresponding multi-pump, multi-cycle configuration shown in FIG. 8. For example, when the assembly of vacuum pumps 300 includes three vacuum pumps (n=3) and three evacuation cycles are performed (k=3), the baseline single-pump system retains approximately 670 times more oxygen than the three-pump, three-cycle configuration. In some embodiments, the assembly of vacuum pumps 300 includes five vacuum pumps (n=5) and five evacuation cycles are performed (k=5), such that the baseline single-pump system retains approximately 6.7×10⁷ times more oxygen than the five-pump, five-cycle configuration. The baseline single-pump system is assumed to operate with a more powerful vacuum pump providing a negative pressure of 80 kPa, or approximately 0.2 atmospheres, while the multi-pump configurations shown in FIG. 9 are assumed to operate with less powerful individual pumps providing a negative pressure of 70 kPa, or approximately 0.3 atmospheres per pump. The table demonstrates that increasing either the number of pumps in the assembly of vacuum pumps 300 or the number of evacuation and inert gas admission cycles reduces oxygen concentration substantially relative to the baseline single-pump system, with the combined effect of multiple pumps and multiple cycles achieving concentration reductions spanning several orders of magnitude.

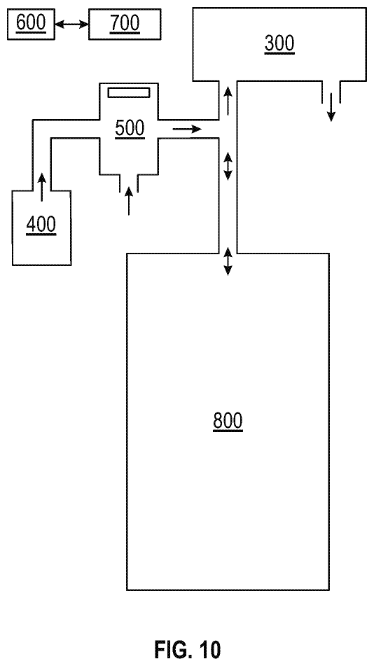

Referring to FIG. 10, the juicer 800 forms a sealed processing chamber for extracting juice from organic material under reduced-oxygen conditions. The juicer 800 includes an enclosed volume that surrounds juicing components, a juice-collecting receptacle, and a pulp-collecting receptacle. The juicer 800 is fluidly coupled to the assembly of vacuum pumps 300, the inert gas source 400, and the valve controller 500 through a gas pathway that communicates with the enclosed volume. The juicer 800 is electrically coupled to the processing unit 600, such that the processing unit 600 controls operation of juicing components within the enclosed volume. The enclosed volume is configured to maintain a hermetic seal during evacuation and inert gas admission cycles, such that gas composition within the enclosed volume is modulated without leakage to an external environment.

The assembly of vacuum pumps 300 draws gas from the enclosed volume of the juicer 800 through vacuum-sealed tubing, reducing pressure within the enclosed volume to a level determined by the number of pumps in series and their respective inlet-to-outlet pressure ratios. The valve controller 500 selectively admits atmospheric air and/or inert gas from the inert gas source 400 into the enclosed volume through the gas pathway, establishing a controlled gas composition within the enclosed volume. The processing unit 600 activates the assembly of vacuum pumps 300 to initiate an evacuation cycle, reducing oxygen concentration in the enclosed volume. After the evacuation cycle, the processing unit 600 activates the valve controller 500 to admit inert gas from the inert gas source 400 into the enclosed volume, diluting any remaining oxygen. The processing unit 600 repeats the evacuation and inert gas admission cycles as needed to achieve a target oxygen concentration within the enclosed volume before organic material is fed to the juicing components.

The elements of the system 700 controlled by the processing unit 600 operate in coordination to reduce oxygen concentration in the juicer 800 before and during juice extraction. The processing unit 600 generates control signals that actuate the assembly of vacuum pumps 300, the valve controller 500, and the juicing components within the enclosed volume according to a selected operational sequence. In some embodiments, the processing unit 600 receives sensor signals from pressure sensors positioned along the gas pathway and compares the received pressure values to threshold values stored in memory, such that the processing unit 600 terminates an evacuation cycle when the pressure within the enclosed volume reaches the threshold value. In some embodiments, the processing unit 600 activates the valve controller 500 to admit inert gas at a pressure higher than atmospheric pressure after an evacuation cycle, such that a subsequent evacuation cycle begins from a higher inert gas pressure and achieves a lower oxygen concentration than would be achieved by starting from atmospheric pressure.

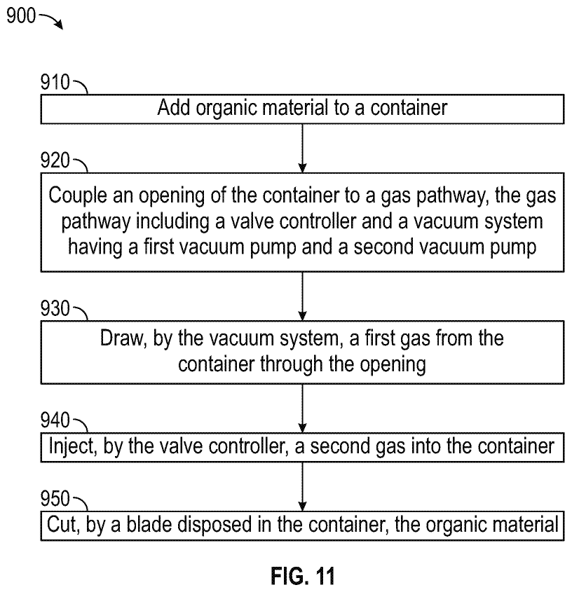

Referring to FIG. 11, a method 900 for reducing oxygen exposure while processing organic material in a container includes steps 910, 920, 930, 940, and 950, according to some embodiments. The method 900 can be executed, performed, or otherwise carried out by the blender system 100 or the juicer 800. The method 900 includes adding organic material to a container, coupling an opening of the container to a gas pathway, drawing a first gas from the container through the opening, injecting a second gas into the container, and cutting the organic material.

The method 900 includes adding organic material to a container (step 910), according to some embodiments. A user places foodstuff, produce, or other organic material into the cup 110 of the blender system 100 and/or into an enclosed volume of the juicer 800. The organic material occupies the foodstuff volume 140 within the cup 110, leaving the space 150 above the top surface 180 of the organic material. In some embodiments, the organic material includes fruits, vegetables, leafy greens, nuts, seeds, and/or dairy products intended for blending into a smoothie and/or beverage. For example, the organic material may include strawberries, bananas, spinach, almond milk, and ice cubes placed together in the cup 110. In some embodiments, the organic material includes whole fruits and/or vegetables intended for juicing, such that the organic material is subsequently fed to a masticating component and/or cutting component within the enclosed volume of the juicer 800. The user secures the lid 160 over the cup 110 after adding the organic material, establishing a hermetic seal over the space 150. The opening 170 in the lid 160 remains available for fluid communication with the isolating assembly 200 after the lid 160 is secured, such that gas can flow between the space 150 and external components during subsequent evacuation and inert gas admission cycles.

The method 900 includes coupling an opening of the container to a gas pathway, the gas pathway including a valve controller and a vacuum system having a first vacuum pump and a second vacuum pump (step 920), according to some embodiments. The user couples the opening 170 of the container (e.g., the cup 110, the enclosed volume of the juicer 800, etc.) to a gas pathway that provides fluid communication between the container and external gas-handling components. The gas pathway includes the valve controller 500 and the vacuum system comprising at least the first vacuum pump 310 and the second vacuum pump 320. In some embodiments, the isolating assembly 200 is positioned between the opening 170 and the inlet 311 of the first vacuum pump 310, such that the gas pathway extends sequentially from the opening 170, through the isolating assembly 200, through vacuum-sealed tubing to the inlet 311, and through the assembly of vacuum pumps 300. For example, the user attaches the isolating assembly 200 to the opening 170 by engaging the coupling part 240 of a first isolating module 210 with a threaded interface formed within the opening 170, such that rotation of the first isolating module 210 secures the isolating assembly 200 to the lid 160 while establishing a hermetic seal that prevents atmospheric air from entering the space 150 during subsequent evacuation and inert gas admission operations. The valve controller 500 is fluidly coupled to the isolating assembly 200 through the common outlet 550, such that gas admitted through the valve controller 500 flows through the common outlet 550, through the isolating assembly 200, and into the space 150 when the processing unit 600 activates either the air valve and/or the inert gas valve within the valves regulating part 510. In some embodiments, the gas pathway includes vacuum-sealed tubing extending from the isolating assembly 200 to the inlet 311 of the first vacuum pump 310, from the outlet 312 of the first vacuum pump 310 to the inlet 321 of the second vacuum pump 320, and from the outlet 322 of the second vacuum pump 320 to any additional downstream pumps in the assembly of vacuum pumps 300.

The method 900 includes drawing, by the vacuum system, a first gas from the container through the opening (step 930), according to some embodiments. The processing unit 600 activates the assembly of vacuum pumps 300 to draw gas from the space 150 through the opening 170, reducing pressure within the container. The first vacuum pump 310 evacuates gas from the space 150 through the inlet 311, lowering pressure in the space 150 to a first reduced pressure determined by an inlet-to-outlet pressure ratio of the first vacuum pump 310. The first vacuum pump 310 expels gas through the outlet 312 into the shared space 314 at the first reduced pressure. The second vacuum pump 320 draws gas from the shared space 314 through the inlet 321 and further reduces pressure in the shared space 314 according to its inlet-to-outlet pressure ratio. The second vacuum pump 320 expels gas through the outlet 322 at a second reduced pressure lower than the first reduced pressure. Gas flows sequentially through each subsequent pump in the assembly of vacuum pumps 300, with each pump further reducing pressure relative to its upstream neighbor. The evacuation cycle terminates when the processing unit 600 receives a sensor signal indicating that the pressure in the space 150 has decreased to a threshold pressure value stored in the one or more memories of the processing unit 600. For example, the threshold pressure value may be set to 0.027 atmospheres when three vacuum pumps are connected in series and each pump reduces its inlet pressure to thirty percent of its outlet pressure, such that the processing unit 600 terminates the evacuation cycle after the pressure in the space 150 reaches approximately 0.027 atmospheres.

The method 900 includes injecting, by the valve controller, a second gas into the container (step 940), according to some embodiments. The processing unit 600 activates the valve controller 500 to admit the second gas into the container after the evacuation cycle terminates. The processing unit 600 transmits a control signal to the valves regulating part 510, opening an inert gas valve positioned between the inert gas inlet 530 and the common outlet 550. Inert gas flows from the inert gas source 400 through the inert gas inlet 530, through the valves regulating part 510, and through the common outlet 550 toward the isolating assembly 200. The inert gas passes through the isolating assembly 200 and enters the space 150 through the opening 170, such that inert gas molecules mix with and dilute any remaining oxygen molecules in the space 150. The processing unit 600 monitors pressure within the space 150 by receiving sensor signals from pressure sensors positioned along the gas pathway. The processing unit 600 compares the received pressure values to a target pressure value stored in the one or more memories.

The processing unit 600 terminates inert gas flow by transmitting a second control signal to the valve controller 500 when the pressure in the space 150 reaches the target pressure value. In some embodiments, the target pressure value is set to approximately atmospheric pressure such that the space 150 is refilled to ambient pressure after the evacuation cycle. For example, the target pressure value may be set to 1.0 atmospheres, such that the processing unit 600 closes the inert gas valve when the pressure in the space 150 increases from 0.027 atmospheres (after evacuation with three pumps) to 1.0 atmospheres. In some embodiments, the target pressure value is set to a pressure higher than atmospheric pressure to establish an overpressure condition before a subsequent evacuation cycle. For example, the target pressure value may be set to 3.0 atmospheres, such that the processing unit 600 admits inert gas until the pressure in the space 150 reaches three times atmospheric pressure, thereby reducing the oxygen-to-inert-gas ratio before the next evacuation cycle begins.

The method 900 includes cutting, by a blade disposed in the container, the organic material (step 950), according to some embodiments. The processing unit 600 activates the motor 120 to initiate blending operations after the desired oxygen concentration has been established in the space 150 through one or more evacuation and inert gas admission cycles. The processing unit 600 transmits a control signal to the motor 120, actuating rotation of the blades 130 within the foodstuff volume 140. The blades 130 rotate at a speed determined by the control signal, cutting and agitating the organic material under the reduced-oxygen conditions present in the space 150. During blending, the blades 130 create bubbles within the organic material, with each bubble containing a reduced concentration of oxygen relative to atmospheric air due to the prior evacuation and inert gas admission cycles. The processing unit 600 maintains activation of the motor 120 for a blending duration determined by user input received through the user interface 520 and/or by a pre-programmed blending profile stored in the one or more memories of the processing unit 600. For example, the processing unit 600 may activate the motor 120 for thirty seconds to blend a smoothie containing soft fruits and leafy greens, or for sixty seconds to blend a mixture containing harder ingredients such as nuts and frozen fruit. After the blending duration elapses, the processing unit 600 transmits a second control signal to the motor 120, terminating rotation of the blades 130. In some embodiments, the processing unit 600 transmits a control signal to the valve controller 500 after blending to open the air inlet 540, admitting atmospheric air into the space 150 through the common outlet 550, the isolating assembly 200, and the opening 170, such that pressure in the space 150 equalizes with ambient atmospheric pressure before the lid 160 is removed from the cup 110.

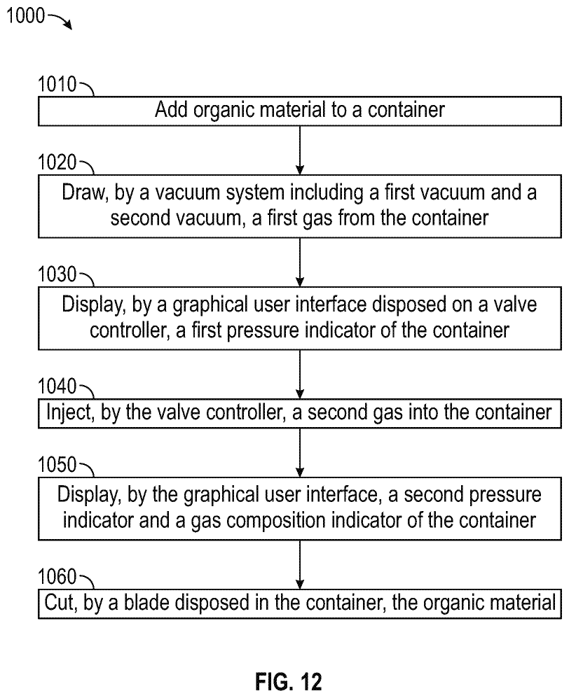

Referring to FIG. 12, a method 1000 for reducing oxygen in a container before cutting organic material includes steps 1010, 1020, 1030, 1040, 1050, and 1060, according to some embodiments. The method 1000 can be executed, performed, or otherwise carried out by the blender system 100 or the juicer 800. The method 1000 includes adding organic material to a container, drawing a first gas from the container, displaying a first pressure indicator, injecting a second gas into the container, displaying a second pressure indicator and a gas composition indicator, and cutting the organic material.

The method 1000 includes adding organic material to a container (step 1010), according to some embodiments. A user places foodstuff, produce, and/or other organic material into the cup 110 of the blender system 100 and/or into an enclosed volume of the juicer 800. The organic material occupies the foodstuff volume 140 within the cup 110, leaving the space 150 above the top surface 180 of the organic material. In some embodiments, the organic material includes fruits, vegetables, leafy greens, nuts, seeds, and/or dairy products intended for blending into a smoothie and/or beverage. For example, the organic material may include strawberries, bananas, spinach, almond milk, and ice cubes placed together in the cup 110. In some embodiments, the organic material includes whole fruits and/or vegetables intended for juicing, such that the organic material is subsequently fed to a masticating component and/or cutting component within the enclosed volume of the juicer 800. The user secures the lid 160 over the cup 110 after adding the organic material, establishing a hermetic seal over the space 150. The opening 170 in the lid 160 remains available for fluid communication with the isolating assembly 200 after the lid 160 is secured, such that gas flows between the space 150 and external components during subsequent evacuation and inert gas admission cycles.

The method 1000 includes drawing, by a vacuum system including a first vacuum and a second vacuum, a first gas from the container (step 1020), according to some embodiments. The processing unit 600 activates the assembly of vacuum pumps 300 to draw gas from the container (e.g., the cup 110, the enclosed volume of the juicer 800, etc.) through the opening 170 and reduce pressure within the space 150. The first vacuum pump 310 evacuates gas from the space 150 through the inlet 311, lowering pressure in the space 150 to a first reduced pressure determined by an inlet-to-outlet pressure ratio of the first vacuum pump 310. The first vacuum pump 310 expels gas through the outlet 312 into the shared space 314 at the first reduced pressure. The second vacuum pump 320 draws gas from the shared space 314 through the inlet 321 and further reduces pressure in the shared space 314 according to its inlet-to-outlet pressure ratio. The second vacuum pump 320 expels gas through the outlet 322 at a second reduced pressure lower than the first reduced pressure. Gas flows sequentially through each subsequent pump in the assembly of vacuum pumps 300, with each pump further reducing pressure relative to its upstream neighbor. The evacuation cycle terminates when the processing unit 600 receives a sensor signal indicating that the pressure in the space 150 has decreased to a threshold pressure value stored in the one or more memories of the processing unit 600. For example, the threshold pressure value may be set to 0.027 atmospheres when three vacuum pumps are connected in series and each pump reduces its inlet pressure to thirty percent of its outlet pressure, such that the processing unit 600 terminates the evacuation cycle after the pressure in the space 150 reaches approximately 0.027 atmospheres.

The method 1000 includes displaying, by a graphical user interface disposed on a valve controller, a first pressure indicator of the container (step 1030), according to some embodiments. The user interface 520 receives sensor signals from one or more pressure sensors positioned along the gas pathway between the space 150 and the assembly of vacuum pumps 300, such that the user interface 520 displays a first pressure indicator reflecting the current pressure in the container after the drawing step 1020. The first pressure indicator is presented on the display screen of the user interface 520 in units such as atmospheres, kilopascals, or millimeters of mercury, and updates continuously as the assembly of vacuum pumps 300 reduces pressure during the evacuation cycle. In some embodiments, the first pressure indicator includes a graphical representation such as a bar graph, a numerical readout, or a color-coded gauge that changes appearance as pressure decreases. For example, the first pressure indicator may display a bar that decreases in length from a full-scale representation at atmospheric pressure to a minimal representation at the target pressure, with the bar color transitioning from green to yellow to red as pressure approaches the target value. The processing unit 600 transmits pressure data to the user interface 520 through an electrical communication link, such that the user interface 520 receives updated pressure values at intervals ranging from approximately 10 milliseconds to approximately 1 second. In some embodiments, the user interface 520 displays additional information alongside the first pressure indicator, such as a cycle count indicating the current evacuation cycle number, a time elapsed since the start of the evacuation cycle, or a percentage completion value calculated by comparing the current pressure to the target pressure. For example, the user interface 520 may display “Cycle 1 of 3” alongside a pressure readout of “0.15 atm” and a completion percentage of “50%,” indicating that the first evacuation cycle is halfway complete based on the current pressure relative to a target pressure of 0.027 atmospheres.

The method 1000 includes injecting, by the valve controller, a second gas into the container (step 1040), according to some embodiments. The processing unit 600 activates the valve controller 500 to admit the second gas into the container after the evacuation cycle terminates. The processing unit 600 transmits a control signal to the valves regulating part 510, opening an inert gas valve positioned between the inert gas inlet 530 and the common outlet 550. Inert gas flows from the inert gas source 400 through the inert gas inlet 530, through the valves regulating part 510, and through the common outlet 550 toward the isolating assembly 200. The inert gas passes through the isolating assembly 200 and enters the space 150 through the opening 170, such that inert gas molecules mix with and dilute any remaining oxygen molecules in the space 150. The processing unit 600 monitors pressure within the space 150 by receiving sensor signals from pressure sensors positioned along the gas pathway.

The processing unit 600 compares the received pressure values to a target pressure value stored in the one or more memories. The processing unit 600 terminates inert gas flow by transmitting a second control signal to the valve controller 500 when the pressure in the space 150 reaches the target pressure value. In some embodiments, the target pressure value is set to approximately atmospheric pressure such that the space 150 is refilled to ambient pressure after the evacuation cycle. For example, the target pressure value may be set to 1.0 atmospheres, such that the processing unit 600 closes the inert gas valve when the pressure in the space 150 increases from 0.027 atmospheres (after evacuation with three pumps) to 1.0 atmospheres. In some embodiments, the target pressure value is set to a pressure higher than atmospheric pressure to establish an overpressure condition before a subsequent evacuation cycle. For example, the target pressure value may be set to 3.0 atmospheres, such that the processing unit 600 admits inert gas until the pressure in the space 150 reaches three times atmospheric pressure, thereby reducing the oxygen-to-inert-gas ratio before the next evacuation cycle begins.

The method 1000 includes displaying, by the graphical user interface, a second pressure indicator and a gas composition indicator of the container (step 1050), according to some embodiments. The user interface 520 receives sensor signals from one or more pressure sensors positioned along the gas pathway between the space 150 and the assembly of vacuum pumps 300 after the processing unit 600 activates the valve controller 500 to admit inert gas into the container. The user interface 520 displays a second pressure indicator reflecting the current pressure in the container after the inert gas injection step 1040. The second pressure indicator is presented on the display screen of the user interface 520 in units such as atmospheres, kilopascals, or millimeters of mercury, and updates continuously as the valve controller 500 admits inert gas into the space 150. The user interface 520 further displays a gas composition indicator on the display screen, where the gas composition indicator reflects the relative concentration of oxygen and inert gas within the space 150 after the inert gas injection.

In some embodiments, the gas composition indicator includes a graphical representation such as a pie chart, a stacked bar graph, or a color-coded percentage readout that changes appearance as the concentration of inert gas increases and the concentration of oxygen decreases. For example, the gas composition indicator may display a pie chart with a first sector representing nitrogen concentration at ninety-seven percent and a second sector representing oxygen concentration at three percent, with the first sector colored blue and the second sector colored red, such that the user visually identifies the reduced oxygen environment established by the evacuation and inert gas admission cycles.

In some embodiments, the user interface 520 displays additional information alongside the second pressure indicator and the gas composition indicator, such as a cycle count indicating the current inert gas admission cycle number, a time elapsed since the start of the inert gas admission cycle, or a percentage completion value calculated by comparing the current pressure to a target pressure stored in the one or more memories of the processing unit 600. For example, the user interface 520 may display “Cycle 2 of 3” alongside a pressure readout of “1.0 atm” and a gas composition readout of “Oxygen: 3%, Nitrogen: 97%,” indicating that the second inert gas admission cycle is complete and the space 150 contains a low-oxygen atmosphere suitable for subsequent blending operations. The processing unit 600 transmits pressure data and gas composition data to the user interface 520 through an electrical communication link, such that the user interface 520 receives updated pressure values and gas composition values at intervals ranging from approximately 10 milliseconds to approximately 1 second.

The method 1000 includes cutting, by a blade disposed in the container, the organic material (step 1060), according to some embodiments. The processing unit 600 activates the motor 120 to initiate blending operations after the desired oxygen concentration has been established in the space 150 through one or more evacuation and inert gas admission cycles. The processing unit 600 transmits a control signal to the motor 120, actuating rotation of the blades 130 within the foodstuff volume 140. The blades 130 rotate at a speed determined by the control signal, cutting and agitating the organic material under the reduced-oxygen conditions present in the space 150.

During blending, the blades 130 create bubbles within the organic material, with each bubble containing a reduced concentration of oxygen relative to atmospheric air due to the prior evacuation and inert gas admission cycles. The processing unit 600 maintains activation of the motor 120 for a blending duration determined by user input received through the user interface 520 and/or by a pre-programmed blending profile stored in the one or more memories of the processing unit 600. For example, the processing unit 600 may activate the motor 120 for thirty seconds to blend a smoothie containing soft fruits and leafy greens, or for sixty seconds to blend a mixture containing harder ingredients such as nuts and frozen fruit.

After the blending duration elapses, the processing unit 600 transmits a second control signal to the motor 120, terminating rotation of the blades 130. In some embodiments, the processing unit 600 transmits a control signal to the valve controller 500 after blending to open the air inlet 540, admitting atmospheric air into the space 150 through the common outlet 550, the isolating assembly 200, and the opening 170, such that pressure in the space 150 equalizes with ambient atmospheric pressure before the lid 160 is removed from the cup 110.

The second gas can have a pressure higher than 1.1 atm and a temperature colder than 15 degrees Celsius (° C.). The second gas may be an inert gas (e.g., nitrogen, argon, etc.) supplied from the inert gas source 400 through the valve controller 500 and into the space 150 of the cup 110 after an evacuation cycle performed by the assembly of vacuum pumps 300. In some embodiments, the second gas has a pressure of approximately 1.5 atm, approximately 2.0 atm, approximately 3.0 atm, between approximately 1.1 atm and approximately 5.0 atm, or between approximately 1.5 atm and approximately 4.0 atm. In some embodiments, the second gas has a temperature of approximately 10 degrees Celsius, approximately 5 degrees Celsius, approximately 0 degrees Celsius, approximately negative 10 degrees Celsius, between approximately negative 20 degrees Celsius and approximately 15 degrees Celsius, or between approximately 0 degrees Celsius and approximately 10 degrees Celsius. For example, the processing unit 600 may activate the valve controller 500 to admit nitrogen at a pressure of approximately 3.0 atm and a temperature of approximately 5 degrees Celsius into the space 150 after an evacuation cycle reduces the pressure in the space 150 to approximately 0.027 atm, such that the nitrogen dilutes residual oxygen in the space 150 and reduces the kinetic energy of gas molecules and organic material molecules within the cup 110 before the blades 130 are actuated by the motor 120.

The first gas drawn from the container by the assembly of vacuum pumps 300 through the opening 170 may include atmospheric air at an initial pressure of approximately 1.0 atm prior to the evacuation cycle. In some embodiments, the first gas has an initial pressure of approximately 0.8 atm, approximately 1.0 atm, approximately 1.2 atm, or between approximately 0.5 atm and approximately 1.5 atm. In some embodiments, the assembly of vacuum pumps 300 reduces the pressure of the first gas in the space 150 to approximately 0.3 atm with a single vacuum pump, approximately 0.09 atm with two vacuum pumps in series, approximately 0.027 atm with three vacuum pumps in series, or approximately 0.0081 atm with four vacuum pumps in series. In some embodiments, the first gas has a temperature of approximately 20 degrees Celsius, approximately 25 degrees Celsius, between approximately 15 degrees Celsius and approximately 30 degrees Celsius, or between approximately 18 degrees Celsius and approximately 28 degrees Celsius. For example, the assembly of vacuum pumps 300 may draw atmospheric air at approximately 1.0 atm and approximately 22 degrees Celsius from the space 150 through the inlet 311 of the first vacuum pump 310, and the first vacuum pump 310 and the second vacuum pump 320 may reduce the pressure in the space 150 to approximately 0.09 atm before the valve controller 500 admits the second gas at a pressure of approximately 2.0 atm and a temperature of approximately 0 degrees Celsius into the space 150 through the common outlet 550 and the isolating assembly 200.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system, comprising:
a container including an opening and a blade configured to cut organic material;
a gas source in fluid communication with the opening;
a valve controller in fluid communication with the gas source;
a first vacuum pump in fluid communication with the container; and
a second vacuum pump in fluid communication with the first vacuum pump,
wherein the first vacuum pump and the second vacuum pump are configured to draw gas from the container through the opening, and
wherein the valve controller is configured to inject gas from the gas source into the container through the opening.

2. The system of claim 1, further comprising a controller including an processor and one or more memories configured to control a speed of the blade, a gas flow through the valve controller, a suction of the first vacuum pump, or a suction of the second vacuum pump.

3. The system of claim 1, further comprising an isolating assembly disposed between the opening and an inlet of the first vacuum pump, wherein the isolating assembly is configured to obstruct solid and liquid organic material from exiting the container through the opening.

4. The system of claim 3, wherein the isolating assembly includes:
an isolating module; and
a membrane positioned within the isolating module, wherein the membrane is configured to facilitate gas flow and obstruct solid and liquid organic material.

5. The system of claim 1, wherein the valve controller includes an internal valve system configured to switch between a first gas input in fluid communication with the gas source and a second gas source in fluid communication with an ambient air source, wherein the internal valve system in further configured to output gas through an outlet.

6. The system of claim 1, wherein the valve controller includes a graphical user interface configured to display system information including a pressure of the system, contents of the container, or a cycle indicator.

7. The system of claim 1, wherein the container further includes:
a cup configured to receive organic material therein;
a lid configured to seal an opening of the cup, wherein the opening of the container is disposed in the lid; and
a motor disposed on a surface of the cup opposite the opening of the cup, wherein the motor is coupled to and configured to actuate the blade.

8. The system of claim 1, further comprising a third vacuum pump in fluid communication with the second vacuum pump and configured to draw gas from the container through the opening.

9. A method, comprising:
adding organic material to a container;
coupling an opening of the container to a gas pathway, the gas pathway including a valve controller and a vacuum system having a first vacuum pump and a second vacuum pump;
drawing, by the vacuum system, a first gas from the container through the opening;
injecting, by the valve controller, a second gas into the container; and
cutting, by a blade disposed in the container, the organic material.

10. The method of claim 9, further comprising:
drawing, after injecting the second gas into the container, by the vacuum system, the second gas from the container; and
injecting, by the valve controller, the second gas into the container.

11. The method of claim 9, wherein the second gas is an inert gas.

12. The method of claim 9, further comprising disposing a membrane between the opening of the container and the first vacuum pump.

13. The method of claim 9, wherein the vacuum system further includes a third vacuum pump.

14. The method of claim 9, further comprising displaying, by a graphical user interface disposed on the valve controller, system information including a pressure of the vacuum system, contents of the container, or a cycle indicator.

15. The method of claim 9, wherein the blade is disposed on a surface of the container opposite the opening.

16. The method of claim 9, further comprising injecting, after the second gas is injected into the container, by the valve controller, the first gas into the container.

17. The method of claim 9, wherein the first gas is ambient air.

18. A method, comprising:
adding organic material to a container;
drawing, by a vacuum system including a first vacuum and a second vacuum, a first gas from the container;
displaying, by a graphical user interface disposed on a valve controller, a first pressure indicator of the container;
injecting, by the valve controller, a second gas into the container;
displaying, by the graphical user interface, a second pressure indicator and a gas composition indicator of the container; and
cutting, by a blade disposed in the container, the organic material.

19. The method of claim 18, further comprising displaying, by the graphical user interface, a status of the organic material.

20. The method of claim 18, wherein the second gas has a pressure higher than 1.1 atm and a temperature colder than 15 ° C.
